(19) United States
(12) Patent Application Publication
(10) Pub. No.: US 2011/0193794 A1
(43) Pub. Date: Aug. 11, 2011

(54) Touch Display Panel

(76) Inventors: Jia-Wei Hu, Hsin-Chu (TW); Fu-Cheng Fan, Hsin-Chu (TW); Chao-Chen Wang, Hsin-Chu (TW); Hsing-Jung Chuang, Hsin-Chu (TW)

(21) Appl. No.: 12/843,055

(22) Filed: Jul. 26, 2010

(30) Foreign Application Priority Data
Feb. 10, 2010 (TW) 099104122

(51) Int. Cl. G06F 3/041

(52) U.S. Cl. 345/173

(57) ABSTRACT

A touch display panel includes a display panel, a second substrate, at least a first spacer and at least a touch sensing unit. The display panel includes a first substrate and a plurality of display units. The first substrate includes a display surface and a non-display surface, and the display units are disposed on the display surface. The second substrate is disposed opposite to the first substrate and is disposed on a side of the non-display surface of the first substrate. The first spacer is disposed between the first substrate and the second substrate to maintain a distance therebetween. The touch sensing unit includes a sensing conductive pad and a conductive unit, wherein a gap is disposed between the sensing conductive pad and the conductive unit.

### BACKGROUND OF THE INVENTION

1. Field of the Invention

The present invention relates to a touch display panel, more particularly, to a touch display panel with high aperture ratio and high light transmittance.

2. Description of the Prior Art

Currently, in the market of various kinds of consumer electronic products, touch panels have been widely applied to portable electronic devices such as personal digital assistants (PDA), mobile phones and notebooks, or even in personal computers and digital home appliances for serving as the interface of information communication tool between the users and the electronic devices. When using the touch panel, the user can directly operate and send out a command through the objects displayed on the panel, thus providing a more user-friendly interface. With the pursuit of electronic products in compact size in the market, conventional input apparatuses, such as operation buttons, keyboard, and mouse have been gradually replaced by touch panel in order to save space. Accordingly, the display device with a touch panel has become the key component of various electronic products.

Based on their differences in structure, the touch display panels can be divided into out-cell touch display panels and in-cell touch display panels. The out-cell touch display panel, besides a display panel, further includes a touch panel on the display surface of the display panel. When the user observes the images displayed by the display panel, the user may execute data input through the touch panel attached on the display panel. Since the touch panel is attached on the display surface of the display panel, the light transmittance of the touch display panel is reduced and the display quality is therefore affected adversely. The in-cell touch display panel, which integrates the touch function into a conventional display panel, can provide both touch input and display functions within one panel. However, since the touch sensing units and the display components are both formed on the substrate, the aperture ratio is reduced, thus adversely affecting the display quality of the in-cell touch display panel.

### SUMMARY OF THE INVENTION

The present invention therefore provides a touch display panel which has high light transmittance without compromising the aperture ratio and also has multi-touch function.

The touch display panel in the present invention includes a display panel, a second substrate, at least a first spacer and at least a touch sensing unit. The display panel includes a first substrate and a plurality of display units. The first substrate includes a display surface and a non-display surface, and the display units are disposed on the display surface. The second substrate is disposed opposite to the first substrate and is disposed on a side of the non-display surface of the first substrate. The first spacer is disposed between the first substrate and the second substrate to maintain a distance therebetween. The touch sensing unit includes a sensing conductive pad and a conductive unit, wherein a gap is disposed between the sensing conductive pad and the conductive unit.

The touch display panel in the present invention can sense the touch position through the sensing conductive pad and the conductive unit, for example, by detecting the electrical connection or the change of the capacitance between the sensing conductive pad and the conductive unit. Since the touch sensing units in the present invention are disposed on a side of the non-display surface of the display panel, the drawbacks of reduced light transmittance in conventional out-cell touch display panels and less aperture ratio in conventional in-cell touch display panels can be alleviated, thus obtaining a better display quality.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a touch display panel according to a first embodiment of the present invention.

FIG. 2 illustrates a schematic diagram of the touch display panel in the present invention when an external force is applied thereto.

FIG. 3 illustrates a schematic diagram of a touch display panel according to another embodiment of the present invention.

FIG. 4 illustrates a schematic diagram of a touch display panel according to still another embodiment of the present invention.

FIG. 5 illustrates a schematic diagram of a touch display panel according to yet another embodiment of the present invention.

FIG. 6 illustrates a schematic diagram of a touch display panel according to yet another embodiment of the present invention.

FIG. 7 illustrates a schematic diagram of a touch sensing array of the touch display panel of the present invention.

### DETAILED DESCRIPTION

To provide a better understanding of the presented invention, preferred embodiments will be made in details. The preferred embodiments of the present invention are illustrated in the accompanying drawings with numbered elements.

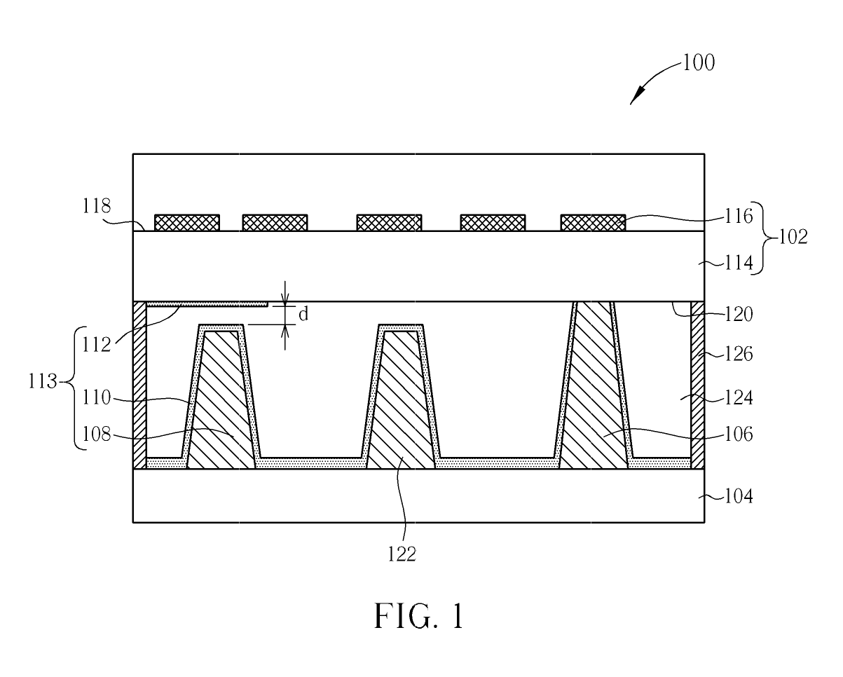

Please refer to FIG. 1, illustrating a schematic diagram of a touch display panel according to a first embodiment of the present invention. As shown in FIG. 1, the touch display panel 100 of the present invention includes a display panel 102, a second substrate 104, at least a first spacer 106, at least a touch mound 108, a conductive layer 110 and at least a sensing conductive pad 112. The touch mound 108, the conductive layer 110 and the sensing conductive pad 112 are disposed between the display panel 102 and the second substrate 104. Preferably, the display panel 102 is a flexible display panel or other panels that can be slightly bended, such as an organic electroluminescence display panel, a reflective liquid crystal display panel or an electrophoretic display panel, but is not limited thereto. The display panel 102 includes a first substrate 114 and a plurality of display components 116. The first substrate 114 is preferably a flexible substrate, but the first substrate 114 may also be a rigid substrate such as a glass substrate, a plastic substrate or a quartz substrate. The first substrate 114 includes a display surface 118 and a non-display surface 120. The display components 116 are disposed on a side of the first substrate 114 facing the display surface 118. The display components 116 include various kinds of components with display function or their combination. For instance, when the display panel 102 is an organic electroluminescence display panel, the display components 116 may be organic light emitting diodes. The second substrate 104 is disposed opposite to the display panel 102 and is disposed on a side of the non-display surface 120 of the first substrate 114. The second substrate 104 may be a transparent substrate or a non-transparent substrate. Preferably, the second substrate 104 is a rigid substrate. In another embodiment, the second substrate 104 may be a flexible substrate.

As shown in FIG. 1, the first spacer 106 is disposed between the first substrate 114 and the second substrate 104 to function as a main spacer. The first spacers 106 are dispersed evenly between the first substrate 114 and the second substrate 104 to maintain a distance therebetween. Preferably, the first spacer 106 includes an elastic material, such as rubber. The touch mound 108, the conductive layer 110 and the sensing conductive pad 112 together form a touch sensing unit 113, which is the main component to carry out the sensing function in the touch display panel 100 of the present invention. In the present embodiment, the touch mound 108 is disposed on a side of the second substrate 104 facing the first substrate 114. The conductive layer 110 is disposed on the second substrate 104. The conductive layer 110 at least covers the surface of the touch mound 108. The sensing conductive pad 112 is disposed on a side of the first substrate 114 facing the second substrate 104. The sensing conductive pad 112 is disposed correspondingly above the touch mound 108 such that a gap d is formed between the sensing conductive pad 112 and the top portion of the conductive layer 110 in the absence of external force. The touch mound 108 may include the same material as the first spacer 106 such as an elastic material which is formed in the same process as the first spacer 106, but is not limited thereto. The conductive layer 110 and the sensing conductive pad 112 may include various kinds of conductive materials. In the present embodiment, the conductive layer 110 is used as a common electrode and is electrically connected to a common voltage. The sensing conductive pad 112 is electrically connected to a signal read-out device (not shown FIG. 1), but is not limited thereto. For example, the sensing conductive pad 112 can be used as a common electrode and is electrically connected to a common voltage while the conductive layer no is electrically connected to a signal read-out device.

As shown in FIG. 1, a sealant 126 and a fluidic layer 124 are disposed between the first substrate 114 and the second substrate 104. The sealant 126 is disposed on the peripheral areas of the first substrate 114 and the second substrate 104 to assemble the first substrate 114 and the second substrate 104. The fluidic layer 124 is disposed in a chamber formed by the first substrate 114, the second substrate 104 and the sealant 126. The fluidic layer 124 includes fluidic material that may be gaseous phase or liquid phase which does not obstruct the pressing of external force in principle.

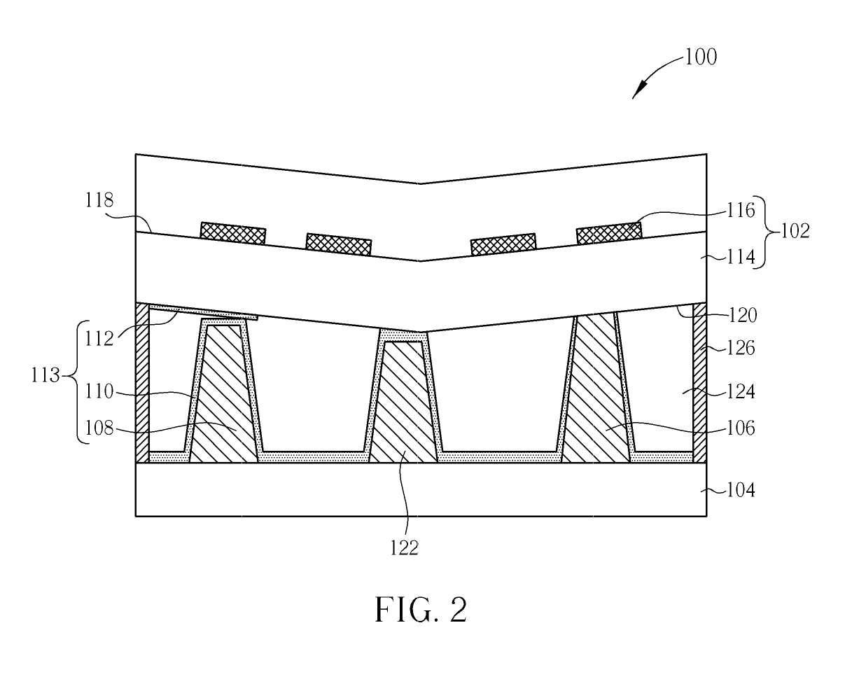

As for the touch sensing method of the touch display panel in the present invention, please refer to FIG. 2, which illustrates a schematic diagram of the touch display panel in the present invention when an external force is applied. As shown in FIG. 2, when a user uses an input device such as a stylus or a finger to press the side of the display surface 118 of the display panel 102 to input a touch signal, the input device would compress a position on the display panel 102 to make the display panel 102 deform at this position. The deformation of the touch panel 102 will make the sensing conductive pad 112 move toward the conductive layer 110, and the sensing conductive pad 112 will eventually contact the conductive layer no. In other words, the pressing will make the conductive layer 110 electrically connected to the sensing conductive pad 112. In the present embodiment, since the conductive layer no is connected to the common voltage, when the conductive layer 110 is electrically connected to the sensing conductive pad 112 due to the external force, the signal read-out device (not shown in FIG. 2) that is connected to the sensing conductive pad 112 can detect the common voltage representing the touch signal. The touch position can be therefore further measured and calculated by relevant circuits. In addition, the first spacer 106 can maintain the distance between the first substrate 114 and the second substrate 104 to avoid mis-contact between the sensing conductive pad 112 and conductive layer 110 in the absence of external force. The detail descriptions of the touch sensing array that can sense the touch position by the sensing conductive pads 112, and the signal read-out devices will be described in the following paragraphs.

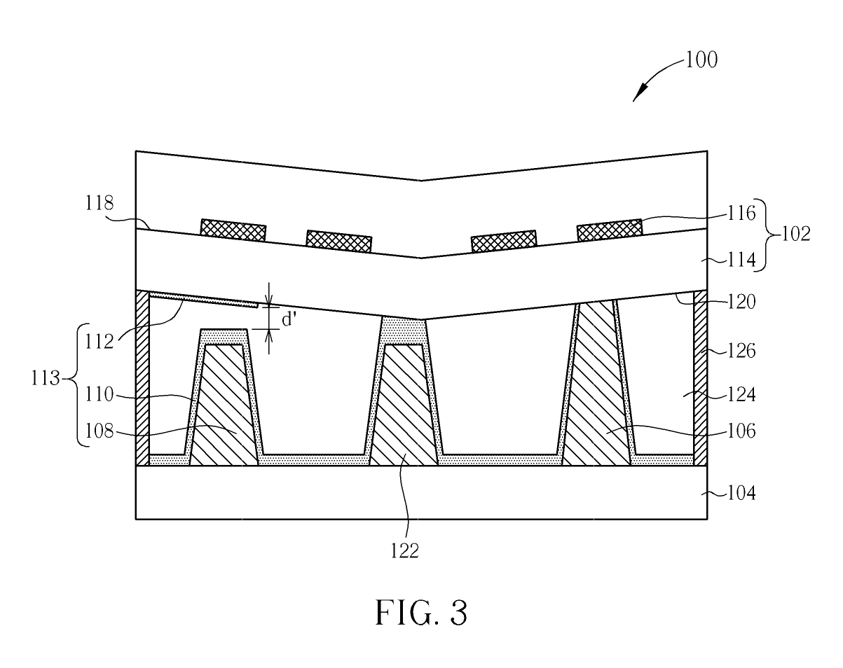

In addition to the abovementioned method that is carried out by the direct electrical connection between the sensing conductive pad 112 and the conductive layer no due to the external force, in another embodiment of the present invention, the touch sensing method can also be performed by detecting the change of the capacitance between the sensing conductive pad 112 and the conductive layer 110. Please refer to FIG. 3, illustrating a schematic diagram of a touch display panel according to another embodiment of the present invention. As shown in FIG. 3, the distance between the first substrate 114 and the second substrate 104 is adjusted. For example, by changing the material of the first substrate 114 to modify its flexibility or by changing the position of the first spacer 106, only a limited degree of deformation is generated when the external force presses the display panel 102. Under this situation, the sensing conductive pad 112 would not contact the touch mound 108 as in the first embodiment. Instead, a gap d′ is disposed between the sensing conductive pad 112 and the touch mound 108. In the present embodiment, due to the change of the gap between the sensing conductive pad 112 and the conductive layer 110, the capacitance between the sensing conductive pad 112 and the conductive layer 110 is changed as well. The change of the capacitance is therefore detected by the signal read-out device connected to the sensing conductive pad 112 and the touch position of the external force can be measured. It is to be noted that, when detecting the change of the capacitance in the present embodiment, the fluidic layer 124 preferably includes a liquid material with appropriate dielectric constant so as to increase the sensitivity of the touch sensing function, but is not limited thereto.

Please again refer to FIG. 1, FIG. 2 and FIG. 3. In another embodiment of the present invention, the touch display panel 100 may optionally further include a second spacer 122. The second spacer 122 is disposed on a side of the second substrate 104 facing the first substrate 114. The second spacer 122 can be formed by the same process as the first spacer 106, but is not limited thereto. When the external force presses the touch panel 102, the second spacer 122 can function as a sub-spacer which can prevent the display panel 102 from being excessively deformed that will cause damages to the display panel 102 or other components. The first spacer 106, the second spacer 122 and the touch mound 108 have different heights when they perform different functions. For example, in the embodiment as in FIG. 2 which shows the conductive layer 110 electrically connected to the sensing conductive pad 110 due to the external force, the first height of the first spacer 106 is greater than the second height of the second spacer 122 and the third height of the touch mound 108. The second height of the second spacer 122 is less or equal to the third height of the touch mound 108. It is therefore the conductive layer 110 can successfully contact the sensing conductive pad 112. In the embodiment as in FIG. 3 which shows the change of the capacitance between the sensing conductive pad 112 and the conductive layer 110, the first height of the first spacer 106 is greater than the second height of the second spacer 122 and the third height of the touch mound 108. The second height of the second spacer 122 is greater or equal to the third height of the touch mound 108. It is therefore the change of the capacitance between the conductive layer 110 and the sensing conductive pad 112 can be detected successfully.

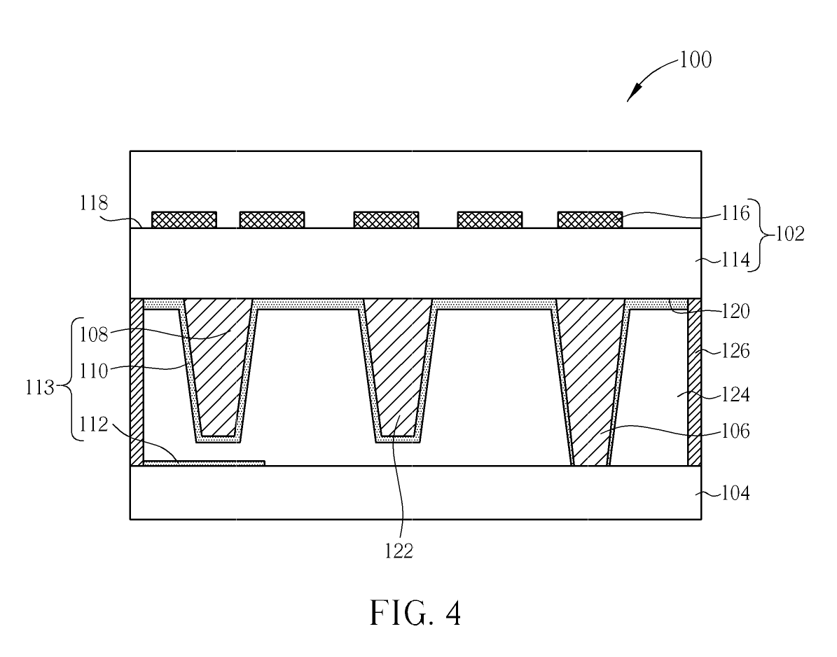

In another embodiment of the present invention, the relative positions of the touch mound 108 and the second spacer 122 can be interchanged. Please refer to FIG. 4, illustrating a schematic diagram of a touch display panel according to another embodiment of the present invention. As shown in FIG. 4, the touch mound 108 and the second spacer 122 are disposed on a side of the non-display surface 120 of the first substrate 114, while the sensing conductive pad 112 is disposed on a side of the second substrate 104 facing the first substrate 114. The sensing conductive pad 112 is disposed corresponding to the touch mound 108. With such a configuration, the touch sensing function as in FIG. 2 and FIG. 3 may also be achieved when the external force is applied.

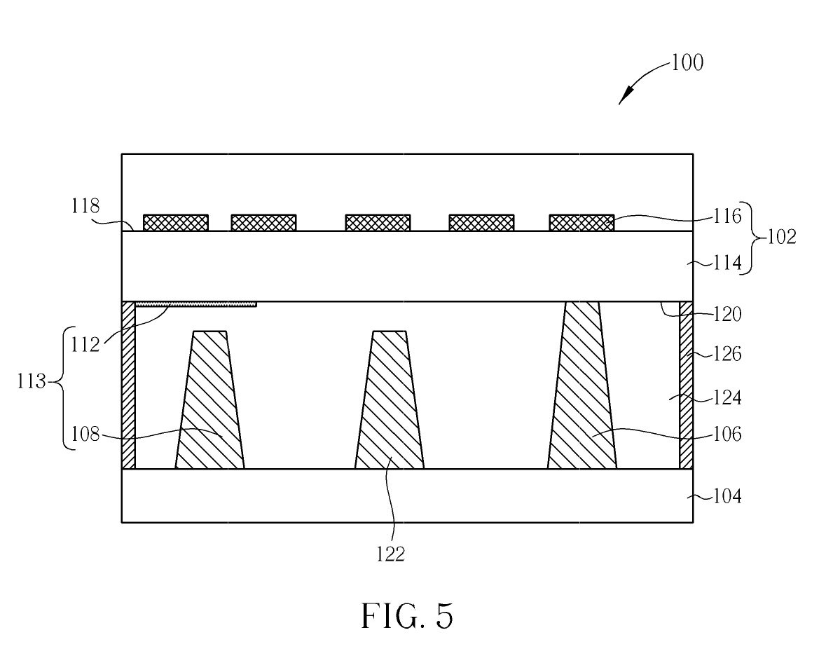

In another embodiment of the present invention, depending on different process requirements, the conductive layer 110 may be disposed not only on the surface of the touch mound 108 but also on the surface of the second substrate 104, the surface of the second spacer 122 and even the surface of the first spacer 106, but the principle is that the layout of the conductive layer 110 should not affect the function of each spacer. Please refer to FIG. 5, illustrating a schematic diagram of a touch display panel according to still another embodiment of the present invention. In the present embodiment, the conductive layer no can be omitted and replaced by the touch mound 108 with electrical conductivity which is directly connected to a common voltage. In the present embodiment, the touch mound 108 includes a conductive material. Preferably, the touch mound 108 includes an elastic conductive material.

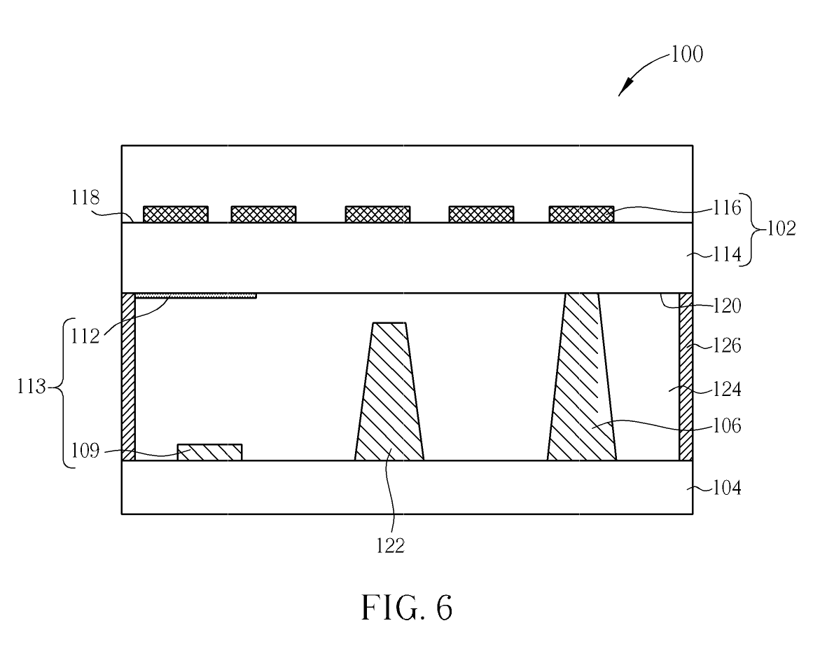

Please refer to FIG. 6, illustrating another embodiment of the present invention. In another embodiment of the present invention, the touch mound 108 can be replaced by a conductive unit 109, for example, a conductive single layer or a conductive multi-layer. In this embodiment, the touch sensing function can also be carried out by detecting the change of the capacitance value between the conductive unit 109 and the sensing conductive pad 112, but should not be limited to. In another embodiment, if the arrangement of the second spacer 122 is well designed, the touch sensing function can be carried out by direct electrical connection between the conductive unit 109 and the sensing conductive pad 112. According to the present embodiment, the conductive unit 109 can have any proper structure that is conductive.

As illustrated in the abovementioned embodiments, the main touch sensing unit 113, such as the combination of the conductive layer no, the touch mound 108 and the sensing conductive pad 112, is disposed on a side of the non-display surface 120 of the display panel 102, so the drawback of light transmittance reduction in conventional out-cell touch display panels can be prevented. Moreover, the touch sensing unit 113, unlike the display component 116, is not disposed on the display surface 116 of the first substrate 114, so the drawback of aperture ratio reduction in conventional in-cell touch display panels can also be alleviated. Accordingly, in the touch display panel 100 of the present invention, the display quality of the display panel 102 is not adversely affected when introducing the touch sensing function.

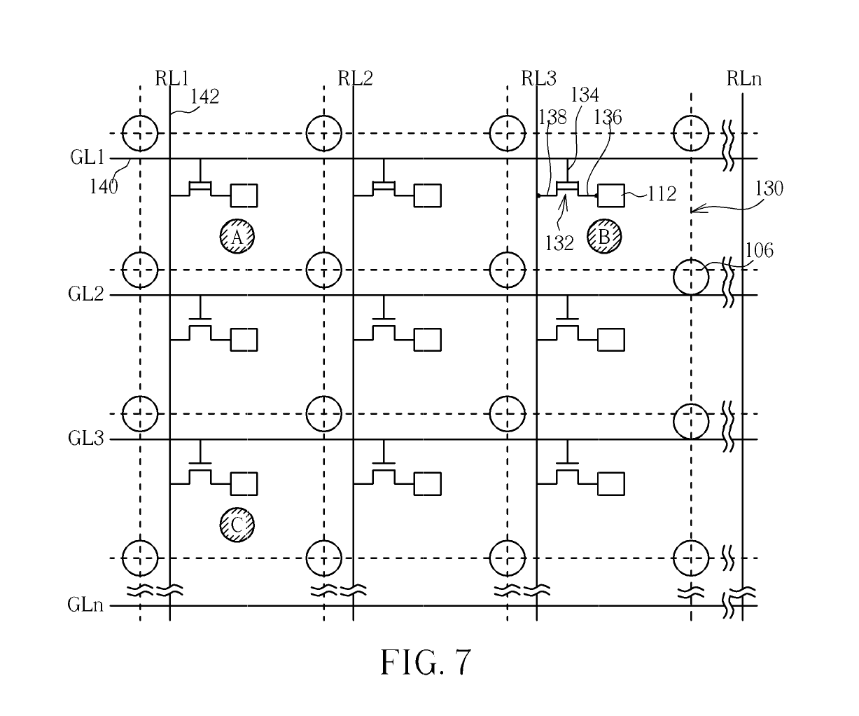

Please refer to FIG. 7, illustrating a schematic diagram of a touch sensing array of the touch display panel of the present invention. As shown in FIG. 7, the touch display panel 100 of the present invention includes a plurality of scan lines 140 (including GL1 to GLn), a plurality of read-out lines 142 (including RL1 to RLn), a plurality of signal read-out devices 132, a plurality of sensing conductive pads 112 and a plurality of first spacers 106. The scan lines 140 and the read-out lines 142 are substantially perpendicular to each other, forming a chessboard-like array. In accordance with the relative positions of the sensing conductive pads 112 and the first spacers 106, a plurality of sensing pixels 130 can be defined on the touch sensing array. Each sensing pixel 130 includes one conductive spacer 106 and one sensing conductive pad 112, but is not limited thereto. In another embodiment of the present invention, the sensing pixel 130 can include one sensing conductive pad 112 and a plurality of first spacers 106. In another embodiment, one first spacer 106 is shared by a plurality of sensing pixels 130. For example, one first spacer 106 is disposed correspondingly in four sensing pixels 130. The abovementioned embodiments can be adjusted based on different product designs. It is understood that the sensing pixel 130 also includes one touch mound 108 and one conductive layer 110 disposed corresponding to another side of the sensing conductive pad 112. For providing a clear description, the touch mound 108 and the conductive layer no are omitted in FIG. 7.

As shown in FIG. 7, each sensing conductive pad 112 is electrically connected to a signal read-out device 132, for example, a thin film transistor (TFT) which includes a gate 134, a source 136 and a drain 138. The gate 134 of the signal read-out device 132 is electrically connected to the scan line 140, the source 136 is electrically connected to the sensing conductive pad 112, and the drain 138 is electrically connected to the read-out line 142. When the sensing conductive pad 112 receives a touch signal (for example, the electrical connection between the conductive layer 110 and the sensing conductive pad 112 as in FIG. 2, or the change of the capacitance as in FIG. 3), the touch signal will be transmitted from the source 136 of the signal read-out device 132 to the drain 138, and will be received by relevant circuits through the read-out line 142. With the coordination of the scanning time of the scan line 140 and the reading time of the read-out line 142, the touch position can be measured accurately.

With the abovementioned structure, the touch display panel 100 of the present invention can provide a multi-touch function. As shown in FIG. 7, if the user touches the sensing pixels 130 in the same row on the touch display panel 100, for example, touches position A and position B, the scan line GL1 turns on the gates 134 of the signal read-out devices 132. The touch signals of position A and position B are detected by the sensing conductive pads 112 of the sensing pixels 130 and are transmitted through the read-out lines RL1 and RL3 respectively. The touch positions are therefore measured and calculated by relevant circuits. If the user touches the sensing pixels 130 in the same column on the touch display panel 100, for example, touches position A and position C, the scan line GL1 is turned on at first, and the read-out line RL1 will receive a touch signal. With the sequentially downward scanning of the scan lines 140, the read-out line RL3 will receive another touch signal subsequently. Accordingly, by using the scanning manner, the relevant circuits will receive multiple touch signals at different time, and thus the touch display panel 100 can detect multiple touch signals even when the sensing pixels 130 at the same column share the same read-out line 142.

In light of above, the touch display panel can sense the touch positions by detecting the electrical connection or the change of the capacitance between the sensing conductive pad and the conductive layer. The touch display panel is able to provide multi touch function as well. Since the touch sensing units are disposed on the side of the non-display surface of the display panel, the display quality of the display panel is not affected and the problems of poor display quality when introducing touch function in conventional arts can be alleviated.

Those skilled in the art will readily observe that numerous modifications and alterations of the device and method may be made while retaining the teachings of the invention.

What is claimed is:

1. A touch display panel, comprising:
a display panel, comprising a first substrate and a plurality of display units, wherein the first substrate comprises a display surface and a non-display surface, and the display units are disposed on the display surface of the first substrate;
a second substrate disposed opposite to the first substrate, wherein the second substrate is disposed on a side of the non-display surface of the first substrate;
at least a first spacer disposed between the first substrate and the second substrate to maintain a distance therebetween; and
at least a touch sensing unit disposed between the first substrate and the second substrate, wherein the touch sensing unit comprises:
a sensing conductive pad; and
a conductive unit disposed corresponding to the sensing conductive pad,
wherein a gap is disposed between the sensing conductive pad and the conductive unit.

2. The touch display panel of claim 1, wherein the sensing conductive pad is disposed on a side of the first substrate facing the second substrate, and the conductive unit is disposed on a side of the second substrate facing the first substrate.

3. The touch display panel of claim 1, wherein the sensing conductive pad is disposed on a side of the second substrate facing the first substrate, and the conductive unit is disposed on a side of the first substrate facing the second substrate.

4. The touch display panel of claim 1, wherein the conductive unit comprises a touch mound.

5. The touch display panel of claim 4, further comprising at least a second spacer disposed between the first substrate and the second substrate.

6. The touch display panel of claim 5, wherein the first spacer has a first height, the second spacer has a second height, and the touch mound has a third height.

7. The touch display panel of claim 6, wherein the first height is greater than the second height and the third height.

8. The touch display panel of claim 6, wherein the second height is substantially equal to the third height.

9. The touch display panel of claim 1, further comprising a sealant and a fluidic layer, wherein the first substrate and the second substrate is assembled by the sealant, and the fluidic layer is disposed among the first substrate, the second substrate and the sealant.

10. The touch display panel of claim 4, wherein the conductive unit further comprises a conductive layer disposed on a side of the touch mound facing the sensing conductive pad.

11. The touch display panel of claim 10, wherein the conductive layer is connected to a common voltage.

12. The touch display panel of claim 4, wherein the touch mound comprises a conductive material.

13. The touch display panel of claim 12, wherein the touch mound is connected to a common voltage.

14. The touch display panel of claim 1, wherein the first spacer comprises an elastic material.

15. The touch display panel of claim 1, wherein the conductive unit is configured to contact the sensing conductive pad when an external force is applied to the display panel.

16. The touch display panel of claim 1, wherein the gap between the conductive unit and the sensing conductive pad is reduced when an external force is applied to the display panel.

17. The touch display panel of claim 1, further comprising a signal read-out device, wherein the sensing conductive pad is electrically connected to the signal read-out device.

18. The touch display panel of claim 17, further comprising a scan line and a read-out line, wherein the signal read-out device comprises a gate, a source and a drain, the source is electrically connected to the sensing conductive pad, the gate is electrically connected to the scan line, and the drain is electrically connected to the read-out line.

19. The touch display panel of claim 1, wherein the display panel comprises a flexible display panel, a TFT-LCD display panel, an organic electroluminescence display panel, a reflective liquid-crystal display device or an electrophoretic display panel.
